(19) United States
(12) Patent Application Publication
(10) Pub. No.: US 2005/0238045 A1
(43) Pub. Date: Oct. 27, 2005

(54) METHOD AND APPARATUS FOR DETECTING RELIABILITY OF FLAG VALUE

(76) Inventors: SHIH-CHUN PENG, Taipei City (TW); Wei-Nan Sun, Kao-Hsiung City (TW); Ti-Wen Yuan, Hsin-Chu County (TW)

Correspondence Address: NORTH AMERICA INTELLECTUAL PROPERTY CORPORATION, P.O. BOX 506, MERRIFIELD, VA, 22116, US

(21) Appl. No.: 10/904,543

(22) Filed: Nov. 16, 2004

(30) Foreign Application Priority Data
Apr. 8, 2004 (TW) 093109821

(51) Int. Cl. H04J 15/00

(52) U.S. Cl. 370/464

(57) ABSTRACT

After a transmitter has encoded a flag value, the flag value is included in a block. A method for analyzing the reliability of the flag value outputted by the transmitter includes receiving the block; according to the received block, obtaining a coded flag value; according to the coded flag value, decoding the coded flag value to obtain a decoded flag result; determining whether or not the received block is or is not a dummy block; and if the received block is determined to be a dummy block, negating the reliability of the decoded flag result; otherwise, analyzing the reliability of the coded flag value to determine whether to affirm or negate the reliability of the decoded flag result.

### BACKGROUND

The invention relates to electronic communication systems, and more particularly, to determining the reliability of an uplink status flag value in a received block in an electronic communication system.

In a GPRS (General Packet Radio Service) or EGPRS (Enhanced General Packet Radio Service) class communication system according to the related art, a base station assigns an uplink time slot according to communication system resources and user end device requests. In order to allocate these time slots, each user end device is given a user identifier. When the base station decides to allocate an uplink time slot to a user end device, the base station includes the user identifier in an uplink status flag (USF), encodes the USF, and then puts the encoded USF into a transmission block, which is then transmitted to the user end device. The user end device receives the block and decodes the value of the USF. If the value of the USF is equal to the user identifier, this means the user end device can transmit data to the base station in the next time slot.

Please refer to FIG. 1. FIG. 1 shows a block diagram of a conventional transmitter 40 and receiver 50. For example, the transmitter 40 could be a GPRS communication system base station and receiver 50 could be a GPRS communication system user end device such as a GPRS handset. The transmitter 40 includes an antenna 41, a radio frequency (RF) transmitting module 42, an interleaver 44, a channel encoder 46, and a USF pre-coder 48. The receiver 50 includes an antenna 51, an RF receiving module 52, an equalizer 54, a deinterleaver 55, a channel decoder 56, a coding scheme decoder 57, and a USF decoder 58.

When the base station decides to allocate an uplink time slot to a user end device, the base station includes the user identifier of the user end device in an uplink status flag (USF), which together with other data including user data and corresponding control data forms a data packet 20 as shown in FIG. 2. As shown in FIG. 2, the USF value is stored in a first section 20a of the data packet 20 and the other data is stored in the remaining portion 20b of the data packet 20. The USF value is first passed to the USF pre-coder 48 where it undergoes pre-coding according to an assigned coding scheme. According to the GPRS or the EGPRS related art communication system standards, there are in total four possible coding schemes: a first coding scheme CS1, a second coding scheme CS2, a third coding scheme CS3, and a fourth coding scheme CS4. For a more detailed explanation of the four coding schemes CS1-CS4, please refer to the GPRS or the EGPRS communication system standards. The following is only a simple explanation of one characteristic of the coding schemes. The USF is formed by a 3-bit data value, and after passing the USF pre-coder 48 when using the first coding scheme CS1, the output of the USF pre-coder 48 is still a 3-bit data value. However, when using the second and third coding schemes CS2, CS3, the output of the USF pre-coder 48 is a 6-bit data value, and when using the fourth coding scheme CS4, the output of the USF pre-coder 48 is a 12-bit data value.

After pre-coding, the USF value (hereafter referred to as the pre-coded USF value) and the other data stored in the remaining portion 20b of the data packet 20 in FIG. 2 are together passed to the channel encoder 46. Using a GPRS system as an example, the channel encoder 46 is a convolution encoder having a code rate of ½. When using the first coding scheme CS1, the convolution encoded USF value (hereafter referred to as the coded USF value) is a 6-bit data value. However, when using the second to fourth coding schemes, the coded USF value is a 12-bit data value. Furthermore, in a GPRS system using the fourth coding scheme CS4, the channel encoder 46 does not play any role and the coded USF value remains a 12-bit data value at the output of the channel encoder 46. From the above, it can be seen that when using the first coding scheme CS1, the coded USF value is 6 bits in length, and when using the second to fourth coding schemes CS2-CS4, the coded USF value is 12 bits in length. After passing the channel encoder 46, the output forms a data packet 22, as shown in FIG. 3. The coded USF value is positioned in the first section 22a of the data packet 22, and the other data is positioned in the remaining portion 22b of the data packet 22.

Because the original USF value is 3 bits in length, there are 8 possible combinations of binary USF values. After passing through the coding process performed by the USF pre-coder 48 and the channel encoder 46, there are still only 8 possible values. These values are referred to as the coded USF set. Different coding schemes CS may have different coded USF sets.

Concerning the output of the channel encoder 46, in a GPRS system, this output may also pass through a puncturing stage (not shown) to modify the code rate. For more detailed information, please refer to the GPRS system standard. Afterwards, the output passes through the interleaver 44, which performs an interleaving operation to change the order of the data in the data packet 22 shown in FIG. 3. Finally, the result of the interleaving operation is combined together according to the coding scheme and passed to the RF transmitting module 42.

FIG. 4 shows the structure of a block 10 transmitted by a GPRS RF transmitting module 42. The block 10 includes four frames 12a, 12b, 12c, and 12d. According to the GPRS system standard, these four frames are further divided into fields: 14a, 14b, 14c, 14d; 16a, 16b, 16c, 16d; and remaining fields (not shown). After the outputted result of the interleaver 44 is passed to the RF transmitting module 42, it is divided into four parts that are filled in the four fields 14a, 14b, 14c, 14d. The RF transmitting module 42 further encodes the coding scheme and the result is divided into four parts and filled in the four fields 16a, 16b, 16c, 16d. After the content of each frame is generated, the entire block 10 undergoes modulation and is then transmitted as an RF signal by the antenna 41.

The RF receiving module 52 of the receiver 50 uses the antenna 51 to receive the RF signal transmitted by the transmitter 40. Regarding the receiver 50, the RF receiving module 52 is electrically connected to the antenna 51 and performs amplification, filtering, demodulation, etc to down-convert the RF signal into a baseband signal. Next, the equalizer 54 performs equalization to compensate for inter-symbol interference (ISI) present in the baseband signal. The outputted result of the equalizer 54 is passed to the deinterleaver 55 to assemble the content of each field 14a, 14b, 14c, 14d and return the order of the data packet 22 to its before interleaving state, which is equivalent to the data packet 22 shown in FIG. 3. Afterwards, the result is passed to the channel decoder 56, which performs channel decoding to generate a decoded data packet equivalent to the data packet 22 shown in FIG. 2. This is then passed upward to the next layer in the communication protocol for further processing.

In the related art, the output of the equalizer 54 is input into a coding scheme decoder 57 where, according to information stored in the fields 16a, 16b, 16c, 16d located in the received block, the coding scheme CS is determined. The output of the deinterleaver 75 is input into a USF decoder 58 where the USF value is retrieved, shown as the first portion 22a in FIG. 3. After USF decoding is complete, the USF value is passed to an upper level of the communication protocol to decide whether or not the next block is allocated for use by the user end device.

As mentioned above, the base station in a GPRS system uses eight different USF values to represent and distinguish eight different user end devices. Thus, after the USF decoder 58 has received the coded USF value, the USF decoder 58 further calculates the correlation between the received coded USF value and the content of the coded USF value and thereby obtains eight correlation indicators. The USF decoder 58 outputs the USF value corresponding to the largest of these eight correlation indicators as its output.

If the USF decoder 58 of a user end device incorrectly decodes the USF value, it will seriously degrade the transmission stability between the base station and the user end devices. Typically the user end device uses two different types of timers to control the communication link between the base station and the user end device. As specified in the GPRS system standard, the first timer type is a T3180 timer and the second timer type is a T3182 timer. Each time the user end device receives its USF, the user end device restarts the T3180 timer to wait for the base station to send the next USF. If during a predetermined time period specified by the initial setting of the T3180 timer, for example within five seconds, the user end device has not received its USF sent by the base station, the T3180 timer will timeout. In this case, if the base station has not assigned the user end device the right to transmit a packet within the predetermined time period, the user end device will discontinue communications with the base station and begin retrying link communications. Conversely, if the user end device receives its USF within the predetermined time period, the T3180 timer is simply restarted for another timing operation.

Furthermore, after the user end device has transmitted a packet, the user end device will start the T3182 timer and wait for the base station to respond with an ACK/NACK control message. An ACK control message indicates that the base station has properly received the packet transmitted by the user end device, while a NACK message indicates that the base station did not receive the packet transmitted by the user end device, or the received packet is not correct. Therefore, if the user end device does not receive the response from the base station within a predetermined period of time specified by the initial setting of the T3182 timer, for example five seconds, the T3182 timer will timeout. This means the communication link between the user end device and the base station will again be interrupted because the user end device will disconnect the communication link and begin retrying for a new communication link.

The errors in decoding by the USF decoder 58 generally result in the following two situations. Firstly, the user end device sends a packet to the base station and restarts the T3180 timer. The base station sends a USF to the user end device permitting the user end device to transmit the packet to the base station, but the user end device USF decoder incorrectly decodes the USF. In this situation, the user end device will continue waiting for a USF until a timeout is reached by the T3180 timer. This causes the user end device to discontinue communications with the base station and begin retrying for a new communication link. In a second situation, the base station does not send a USF to the user end device, however, a decoding error in the USF decoder 58 causes the USF value in the block to be decoded as the user end device's corresponding USF. This causes the user end device to mistakenly transmit a packet to the base station. This unauthorized transmission by the user end device interferes with another user end device's authorized transmission. In addition to this, because the user end device mistakenly believes it is receiving its USF, it will continuously restart the T3180 timer, which will not be able to normally timeout. This prevents the communication link between the base station and the user end device from being disconnected. On the other hand, after the user end device has transmitted a packet, it will start the T3182 timer and wait for the base station to respond with an ACK/NACK message. Because the base station can not receive the improper packet send by the user end device, the base station will not send a response to the user end device and the T3182 timer will timeout. Therefore, the user end device mistakenly disconnects the communication link with the base station and begins retrying for a new communication link.

In summery, noise and interference in a communication system may cause a user end device to mistakenly decode a received USF to match the user end device's own USF value. Because of this, the T3180 timer will mistakenly timeout and the communication link will be disconnected, the T3182 timer will mistakenly timeout and the communication link will be disconnected, or the T3180 timer will not be able to timeout and the communication link will be unable to be disconnected. Additionally, in a GPRS system, the base station will occasionally send a dummy frame, and this dummy frame will not necessarily contain any USF data. In this case, a related art user end device will still perform a USF decoding operation and use the resulting USF value. This may cause the communication link to be interrupted and will seriously influence the throughput and stability of the communication link between the user end device and the base station. For these reasons, a related art GPRS handset is extremely susceptible to errors caused by mistaken USF decoding, which degrades communication with the base station. It would be beneficial to find a solution to this problem.

### SUMMARY

One objective of the claimed invention is therefore to provide a method and apparatus for determining the reliability of USF value included in a received block according to signal quality indicators, signal power values and coded USF correlation indicators for the frames in the received block, to solve the above-mentioned problems.

According to an exemplary embodiment of the claimed invention, a method is disclosed for analyzing the reliability of a flag value outputted by a transmitter, after the transmitter has encoded the flag value, the flag value being included in a block, the method comprising (a) receiving the block; (b) obtaining a coded flag value according to the received block; (c) decoding the coded flag value to obtain a decoded flag result; and (d) determining whether the received block is or is not a dummy block, and negating the reliability of the decoded flag result if the block is determined to be a dummy block.

According to another exemplary embodiment of the claimed invention, a method is disclosed for analyzing the reliability of a flag value outputted by a transmitter, after the transmitter has encoded the flag value, the flag value being included in a block, the method comprising (a) receiving the block; (b) obtaining a coded flag value according to the received block; (c) decoding the coded flag value to obtain a decoded flag result; (d) determining whether the received block is or is not a dummy block; if the block is determined to be a dummy block, negating the reliability of the decoded flag result, otherwise proceeding to step (e); and (e) if the received block is not a dummy block, analyzing the reliability of the coded flag value to decide whether to affirm or negate the reliability of the decoded flag result.

According to another exemplary embodiment of the claimed invention, a flag reliability analysis apparatus is disclosed for analyzing the reliability of a flag value outputted by a transmitter. Wherein, after the transmitter has encoded the flag value, the flag value is included in a block, and the block comprises at least one frame. The apparatus comprises a receiving module for receiving the block outputted by the transmitter; measuring a signal quality indicator and a signal power value for each frame in the received block; according to the received block, obtaining a coded flag value; according to the coded flag value, decoding the coded flag value to obtain a decoded flag result; and performing a correlation operation on the coded flag value and all possible values of the coded flag value to obtain a plurality of coded flag correlation indicators; and a dummy block detection module electrically connected to the receiving module for determining whether the received block is or is not a dummy block, wherein if the received block is determined to be a dummy block, the flag reliability analysis apparatus outputs a negative signal to negate the reliability of the decoded flag result.

According to another exemplary embodiment of the claimed invention, a flag reliability analysis apparatus is disclosed for analyzing the reliability of a flag value outputted by a transmitter. Wherein, after the transmitter has encoded the flag value, the flag value is included in a block, and the block comprises at least one frame. The apparatus comprises a receiving module for receiving the block outputted by the transmitter; measuring a signal quality indicator and a signal power value for each frame in the received block; according to the received block, obtaining a coded flag value; according to the coded flag value, decoding the coded flag value to obtain a decoded flag result; and performing a correlation operation on the coded flag value and all possible values of the coded flag value to obtain a plurality of coded flag correlation indicators; a dummy block detection module electrically connected to the receiving module for determining whether the received block is or is not a dummy block, and a reliability analysis module electrically connected to the receiving module and the dummy block detection module; wherein if the received block is determined to be a dummy block, the reliability analysis module analyzes the reliability of the coded flag value to determine whether to affirm or negate the reliability of the decoded flag result.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a receiver and transmitter according to the related art.

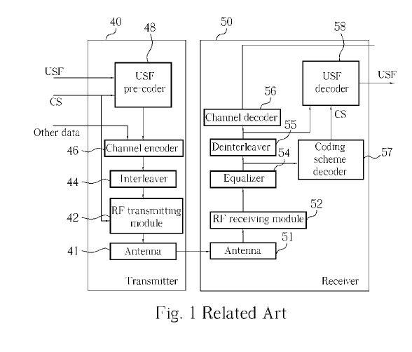

FIG. 2 is a data packet according to the related art.

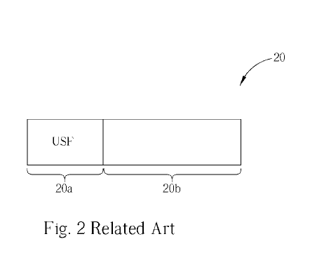

FIG. 3 is an encoded data packet according to the related art.

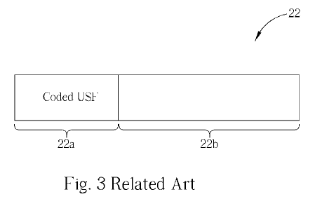

FIG. 4 a detailed diagram showing the structure of a block transmitted by a GPRS RF transmitter according to the related art.

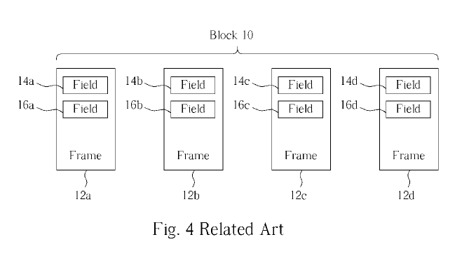

FIG. 5 is a block diagram of a receiver according to the present invention.

FIG. 6 is a flowchart describing the USF reliability analysis operation performed in the receiver shown in FIG. 5.

### DETAILED DESCRIPTION

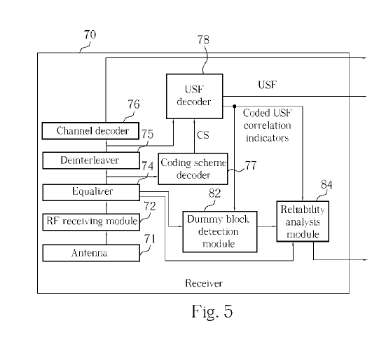

Please refer to FIG. 5. FIG. 5 shows a block diagram of a receiver 70 according to an embodiment of the present invention. In this embodiment, the receiver 70 is a user end device (such as a GPRS handset) in a GPRS system, wherein a corresponding transmitter is a GPRS system base station. As the operation of the transmitter has already been explained, a repeated description is hereby omitted. The receiver 70 includes an antenna 71, an RF receiving module 72, an equalizer 74, a deinterleaver 75, a channel decoder 76, a coding scheme decoder 77, and a USF decoder 78. With the exception of the equalizer 74, the operation of these components is the same as has already been described for the related art. As such, a repeated description is hereby omitted. According to the present invention, the receiver 70 further includes a dummy block detection module 82 and a reliability analysis module 84.

The dummy block detection module 82 is electrically connected to the equalizer 74 and the USF decoder 78 for determining whether the block transmitted by the transmitter to the receiver 70 is a dummy block. Additionally, the reliability analysis module is electrically connected to the equalizer 74, the USF decoder 78, and the dummy block detection module 82 for performing an analysis on the output of the USF decoder 78 to thereby generate a USF reliability signal.

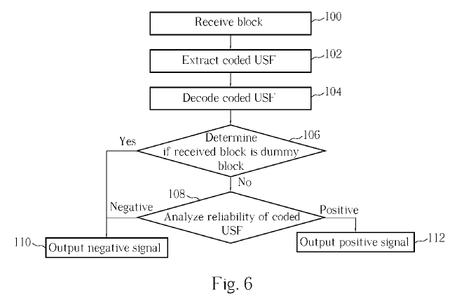

In order to further explain the USF reliability analysis performed in the receiver 70 according to the present invention, please refer to FIG. 6. FIG. 6 shows a flowchart describing the USF reliability analysis operation performed in the receiver 70 shown in FIG. 5. The flowchart includes the following steps:

Step 100: Receive a block.

Step 102: According to the received block, extract an coded USF value.

Step 104: Decode the coded USF value to obtain a decoded USF result.

Step 106: Determine whether the received block is a dummy block. If yes, proceed to step 110; otherwise, proceed to step 108.

Step 108: Analyze the reliability of the coded USF value. If the result is negative, proceed to step 110; otherwise, proceed to step 112.

Step 110: Output a negative signal to negate the reliability of the decoded USF result, which indicates the decoded USF result is unreliable.

Step 112: Output a positive signal to affirm the reliability of the decoded USF result, which indicates the decoded USF result is reliable.

The preferred embodiment of the present invention is used in a GPRS system. Concerning the operation of the receiver 70, the process starting from the receiver 70 receiving the received block (step 100), extracting an coded USF value (step 102) according to the received block, and decoding the coded USF value to obtain a decoded USF result (step 104) according to the received coded USF value, is substantially the same as already explained for the related art and is therefore not repeated here. The following description instead focuses on the features of the present invention.

According to the present invention receiver 70, besides using the equalizer 74 to compensate for the inter symbol interference (ISI) present in the base band signal, the equalizer 74 is used to calculate a signal quality indicator and signal power level for each frame. Each frame's signal quality indicator is passed to the dummy block detection module 82, and each frame's power level is passed to the reliability analysis module 84. The signal quality indicator is a numerical value used to correspond to the quality situation of the frame. As an implementation example, the signal quality indicator could be a signal to noise ratio.

Because it is already known that the dummy block does not contain a valid USF value, the coded USF correlation indicators generated by the USF decoder 78 should all be very small. Therefore, when all the correlation indicators are very small, this indicates the block is possibly a dummy block. Additionally, it is already known that another characteristic of a dummy block is that each frame in the dummy block does not pass through encoding protection, and has been carefully designed such that the signal quality indicator of each frame in a dummy block will have a low value. Because of this, when the signal quality indicator is of a low value, this represents that the frame is possibly a dummy frame. Using the above mentioned dummy block and dummy frame characteristics, the dummy block detection module 82, according to each frame's signal quality indicator, and/or coded USF correlation indicators determines whether or not the block is a dummy block. Using these guidelines for step 106, there can be several different implementations as described in the following examples.

A first method for determining dummy blocks by the detection module 82 involves calculating an average signal quality indicator Q_{A} for all the frames in the received block. If the average value Q_{A} is less than a predetermined level, determine the received block to be a dummy block. Otherwise, determine the received block to not be a dummy block.

A second method for determining dummy blocks by the detection module 82 involves determining whether each frame in the received block is a dummy frame. If a frame's signal quality indicator is less than a predetermined level, determine the frame to be a dummy frame. If the number of dummy frames in the received block is greater than a predetermined number, determine the received block to be a dummy block.

A third method for determining dummy blocks by the detection module 82 involves if the coded USF correlation indicators are all less than a predetermined value, determining the received block to be a dummy block.

A fourth method for determining dummy blocks by the detection module 82 involves if the average signal quality indicator Q_{A} for all the frames in the received block is less than a predetermined level, or if the coded USF correlation indicators are all less than a predetermined value, determining the received block to be a dummy block.

Due to the fourth method for determining dummy blocks, a fifth method for determining dummy blocks by the detection module 82 involves if the average signal quality indicator Q_{A} is less than another predetermined level and the coded USF correlation indicators are all less than another predetermined value, determining the received block to be a dummy block.

In step 108, the reliability analysis module 84 determines the reliability of the coded USF value according to the coded USF correlation indicators, and/or each frame's signal power. When the reliability analysis mode 84 receives the result outputted by the dummy block detection module 82, if the dummy block detection module 82 determines the received block to be a dummy block, the reliability analysis module 84 outputs a negative signal. This indicates a poor reliability for the USF value in the received block. If the dummy block detection module 82 does not determine the received block to be a dummy block, the reliability analysis module 84 determines the reliability of the USF value according to the coded USF correlation indicators.

When the decoded USF value matches the USF value of the user end device, the corresponding coded USF correlation indicator will be the highest while the other coded USF correlation indicators will be relatively lower. Conversely, if the largest of the coded USF correlation indicators do not have particularly large values, this indicates the decoded USF value outputted by the USF decoder 78 is not very reliable. Using this logic, in step 108, analyzing the received coded USF value can have several implementations as shown in the following examples.

A first reliability analysis method involves obtaining a largest value C₁ and an average value C_{A} of the coded USF correlation indicators. If the difference between the largest value C₁ and the average value C_{A} is greater than a predetermined value, affirm the reliability of the USF value and the reliability analysis module 84 outputs a positive signal. Otherwise the reliability analysis module 84 outputs a negative signal.

A second reliability analysis method involves obtaining a largest value C₁ and a second largest value C₂ of the coded USF correlation indicators. If the difference between the largest value C₁ and the second largest value C₂ is greater than a predetermined value, affirm the reliability of the USF value and the reliability analysis module 84 outputs a positive signal. Otherwise the reliability analysis module 84 outputs a negative signal.

Further, the signal power level for each frame also reflects the USF reliability. When the signal power level for each frame is too low, this indicates the USF value outputted by the USF decoder 58 may not be very reliable. Using this logic, in step 108, analyzing the coded USF value can have several more implementations as shown in the following examples.

A third reliability analysis method involves obtaining a largest signal power level P₁ for the frames. If the largest level P₁ is greater than a predetermined level, affirm the reliability of the USF value and the reliability analysis module 84 outputs a positive signal. Otherwise the reliability analysis module 84 outputs a negative signal.

A fourth reliability analysis method involves obtaining an average signal power level P_{A} for the frames. If the average level P_{A} is greater than a predetermined level, affirm the reliability of the USF value and the reliability analysis module 84 outputs a positive signal. Otherwise the reliability analysis module 84 outputs a negative signal.

In these embodiments, the reliability analysis module 84 uses probability and statistics to check the trustworthiness of the USF value and sets the predetermined values according to the different coding schemes. It should also be noted that the present invention reliability analysis module 84 could also use other calculation methods to check the trustworthiness of the USF value and the present invention is not limited to the examples shown above.

According to the present invention, the USF reliability is analyzed in the receiver, and the user end device can clearly determine whether or not to use the decoded USF value. This greatly reduces the chance of mistakenly using an invalid USF. Especially in the case that the received block is a dummy block, the signal strength is too low, or noise levels are too high, the related art will mistakenly use and decode the USF value. This leads to invalid decisions based on the mistaken USF. As such, the present invention reduces timeouts by the user end device T3180 and T3182 timers and the associated communication link disconnects. Situations where the T3180 timer cannot timeout and is therefore unable to disconnect the link and other situations causing communication link interference or disconnects are also reduced. In this way, the present invention assures the stability of the communication link between the user end device and base station.

Those skilled in the art will readily observe that numerous modifications and alterations of the device may be made while retaining the teachings of the invention. Accordingly, the above disclosure should be construed as limited only by the metes and bounds of the appended claims.

1. A method of analyzing the reliability of a flag value outputted by a transmitter, after the transmitter has encoded the flag value, the flag value being included in a block, the method comprising:
(a) receiving the block;
(b) obtaining a coded flag value according to the received block;
(c) decoding the coded flag value to obtain a decoded flag result; and
(d) determining whether the received block is or is not a dummy block, and negating the reliability of the decoded flag result if the block is determined to be a dummy block.

2. The method of claim 1, further comprising:
(e) if the received block is determined not to be a dummy block, analyzing the reliability of the coded flag value to decide whether to affirm or negate the reliability of the decoded flag result.

3. The method of claim 2, further comprising:
measuring a signal quality indicator and a signal power of each frame in the received block; and
performing a correlation operation on the coded flag value and all possible values of the coded flag value to obtain a plurality of coded flag correlation indicators.

4. The method of claim 3, wherein step (d) further comprises determining whether the received block is or is not a dummy block according to the signal quality indicator for each frame in the received block.

5. The method of claim 4, wherein step (d) further comprises:
calculating an average value (Q_{A}) of the signal quality indicators for frames in the received block; and
determining the received block to be a dummy block if the average value (Q_{A}) is less than a first predetermined value.

6. The method of claim 4, wherein step (d) further comprises:
determining whether each frame in the received block is a dummy frame, wherein if the signal quality indicator for a frame is less than a second predetermined value, determining the frame to be a dummy frame; and
determining the received block to be a dummy block if the number of dummy frames in the received block is greater than a third predetermined value.

7. The method of claim 3, wherein step (d) further comprises determining whether the received block is or is not a dummy block according to the coded flag correlation indicators.

8. The method of claim 7, wherein step (d) further comprises:
determining the received block to be a dummy block if the coded flag correlation indicators are all less than a fourth predetermined threshold.

9. The method of claim 3, wherein step (d) further comprises:
determining the received block to be a dummy block if the average value (Q_{A}) of the signal quality indicators for the frames of the received block is less than a fifth predetermined value or if the coded flag correlation indicators are all less than a sixth predetermined value.

10. The method of claim 9, wherein step (d) further comprises:
determining the received block to be a dummy block if the average value (Q_{A}) of the signal quality indicators is less than a seventh predetermined value and the coded flag correlation indicators are all less than an eighth predetermined value.

11. The method of claim 3, wherein step (e) further comprises analyzing the reliability of the coded flag value according to the coded flag correlation indicators.

12. The method of claim 11, wherein step (e) further comprises:
determining a largest value (C₁) of the coded flag correlation indicators;
determining an average value (C_{A}) of the coded flag correlation indicators;
calculating a ratio (RC_{1A}) between the largest value (C₁) and the average value (C_{A}); and
negating the reliability of the decoded flag result if the ratio (RC_{1A}) is less than a ninth predetermined value.

13. The method of claim 11, wherein step (e) further comprises:
determining a largest value (C₁) of the coded flag correlation indicators;
determining a second largest value (C₂) of the coded flag correlation indicators;
calculating a ratio value (RC₁₂) between the largest value (C₁) and the second largest value (C₂); and
negating the reliability of the decoded flag result if the ratio (RC₁₂) is less than a tenth predetermined value.

14. The method of claim 3, wherein in step (e), analyzing the reliability of the received coded flag value is performed according to the signal power of each frame.

15. The method of claim 14, wherein step (e) further comprises:
determining a largest value (P₁) of the signal powers; and
negating the reliability of the decoded flag result if the largest value (P₁) is less than an eleventh predetermined threshold.

16. The method of claim 14, wherein step (e) further comprises:
calculating an average value (P_{A}) of the signal powers; and
negating the reliability of the decoded flag result if the average value (P_{A}) is less than a twelfth predetermined value.

17. A method of analyzing the reliability of a flag value outputted by a transmitter, after the transmitter has encoded the flag value, the flag value being included in a block, the method comprising:
(a) receiving the block;
(b) obtaining a coded flag value according to the received block;
(c) decoding the coded flag value to obtain a decoded flag result;
(d) determining whether the received block is or is not a dummy block; if the block is determined to be a dummy block, negating the reliability of the decoded flag result, otherwise proceeding to step (e); and
(e) if the received block is not a dummy block, analyzing the reliability of the coded flag value to decide whether to affirm or negate the reliability of the decoded flag result.

18. A flag reliability analysis apparatus for analyzing the reliability of a flag value outputted by a transmitter, after the transmitter has encoded the flag value, the flag value being included in a block, the block comprising at least one frame, the apparatus comprising:
a receiving module for receiving the block outputted by the transmitter;
measuring a signal quality indicator and a signal power for each frame in the received block; according to the received block, obtaining a coded flag value; according to the coded flag value, decoding the coded flag value to obtain a decoded flag result; and performing a correlation operation on the coded flag value and all possible values of the coded flag value to obtain a plurality of coded flag correlation indicators; and
a dummy block detection module electrically connected to the receiving module for determining whether the received block is or is not a dummy block, wherein if the received block is determined to be a dummy block, the flag reliability analysis apparatus outputs a negative signal to negate the reliability of the decoded flag result.

19. The apparatus of claim 18, further comprising:
a reliability analysis module electrically connected to the receiving module and the dummy block detection module, wherein if the received block is determined to be a dummy block, the reliability analysis module analyzes the reliability of the coded flag value to determine whether to affirm or negate the reliability of the decoded flag result.

20. The apparatus of claim 18, wherein the dummy block detection module determines whether the received block is or is not a dummy block according to the signal quality indicator of each frame in the received block.

21. The apparatus of claim 20, wherein the dummy block detection module calculates an average value (Q_{A}) of the signal quality indicators for each frame of the received block, and if the average value (Q_{A}) is less than a first predetermined value, determines the received block to be a dummy block.

22. The apparatus of claim 20, wherein the dummy block detection module calculates the number of dummy frames in the received block, and if the number of dummy frames is greater than a second predetermined value, determines the received block to be a dummy block, wherein if the signal quality indicator for a frame is less than a third predetermined value, the dummy block detection module determines the frame to be a dummy frame.

23. The apparatus of claim 18, wherein the dummy block detection module determines whether the received block is or is not a dummy block according to the coded flag correlation indicators.

24. The apparatus of claim 23, wherein the dummy block detection module checks whether all the coded flag correlation indicators are less than a fourth predetermined value, and if yes, determines the received block to be a dummy block.

25. The apparatus of claim 18, wherein the dummy block detection module calculates an average signal value (Q_{A}) of the signal quality indicators for frames in the received block, and if the average value (Q_{A}) is less than a fifth predetermined value, or if the coded flag correlation indicators are all less than a sixth predetermined value, determines the received block to be a dummy block.

26. The apparatus of claim 25, wherein the dummy block detection module further checks whether the average value (Q_{A}) is less than a seventh predetermined value, and whether the coded flag correlation indicators are all less than an eighth predetermined value, wherein if yes, the dummy block detection module determines the received block to be a dummy block.

27. The apparatus of claim 19, wherein the reliability analysis module analyzes the reliability of the coded flag value according to the coded flag correlation indicator values.

28. The apparatus of claim 27, wherein the reliability analysis module calculates a largest value (C₁) and an average value (C_{A}) of the coded flag correlation indicators, calculates a ratio (RC_{1A}) between the largest value (C₁) and the average value (C_{A}), and if the ratio (RC_{1A}) is less than a ninth predetermined value, negates the reliability of the decoded flag result.

29. The apparatus of claim 27, wherein the reliability analysis module calculates a largest value (C₁) and a second largest value (C₂) of the coded flag correlation indicators, calculates a ratio (RC₁₂) between the largest value (C₁) and the second largest value (C₂), and if the ratio (RC₁₂) is less than a tenth predetermined value, negates the reliability of the decoded flag result.

30. The apparatus of claim 19, wherein the reliability analysis module analyzes the reliability of the coded flag value according to the signal power of each frame.

31. The apparatus of claim 30, wherein the reliability analysis module calculates a largest value (P₁) of the signal powers, and if the largest value (P₁) is less than an eleventh predetermined value, negates the reliability of the decoded flag result.

32. The apparatus of claim 30, wherein the reliability analysis module calculates an average value (P_{A}) of the signal powers, if the average value (P_{A}) is less than a twelfth predetermined value, negates the reliability of the decoded flag result.

33. A flag reliability analysis apparatus for analyzing the reliability of a flag value outputted by a transmitter, after the transmitter has encoded the flag value, the flag value being included in a block, the block comprising at least one frame, the apparatus comprising:
a receiving module for receiving the block outputted by the transmitter;
measuring a signal quality indicator and a signal power for each frame in the received block; according to the received block, obtaining a coded flag value; according to the coded flag value, decoding the coded flag value to obtain a decoded flag result; and performing a correlation operation on the coded flag value and all possible values of the coded flag value to obtain a plurality of coded flag correlation indicators;
a dummy block detection module electrically connected to the receiving module for determining whether the received block is or is not a dummy block, and
a reliability analysis module electrically connected to the receiving module and the dummy block detection module; wherein if the received block is determined to be a dummy block, the reliability analysis module analyzes the reliability of the coded flag value to determine whether to affirm or negate the reliability of the decoded flag result.
